(19) United States
(12) Patent Application Publication
(10) Pub. No.: US 2026/0071906 A1
(43) Pub. Date: Mar. 12, 2026

(54) RADAR FILL LEVEL MEASURING DEVICE FOR DETECTING THE FILL LEVEL OF A MEDIUM WITH LOW PERMITTIVITY IN A CONTAINER

(71) Applicant: KROHNE Messtechnik GmbH, Duisburg (DE)

(72) Inventors: Christian SCHULZ, Bochum (DE); Christoph SCHMITS, Dortmund (DE)

(73) Assignee: KROHNE Messtechnik GmbH, Duisburg (DE)

(21) Appl. No.: 19/386,710

(22) Filed: Nov. 12, 2025

Related U.S. Application Data
(63) Continuation of application No. PCT/EP2024/061361, filed on Apr. 25, 2024.

(30) Foreign Application Priority Data
May 12, 2023 (DE) 10 2023 112 582.6

(51) Int. Cl. G01F 23/284; H01Q 1/22; H01Q 15/14; H01Q 15/24

(52) U.S. Cl. CPC G01F 23/284; H01Q 1/225; H01Q 15/14; H01Q 15/24

(57) ABSTRACT

A radar fill level measuring device for detecting the level of a medium with low permittivity located in a container is shown and described, with a feed and receiving element arranged outside the container for generating and receiving electromagnetic radiation, with a measuring window in the wall of the container that is permeable to electromagnetic radiation, with a waveguide arranged in the container and extending over a level measurement range. The waveguide can be flooded by the medium. The feed and receiving element, the measuring window and the waveguide form a measuring path over which, during measuring operation, electromagnetic radiation generated by the feed and receiving element propagates through the measuring window and through the waveguide during measurement operation. Electromagnetic radiation reflected from a medium surface in the waveguide is guided back through the waveguide and through the measuring window to the feed and receiving element.

This nonprovisional application is a continuation of International Application No. PCT/EP2024/061361, which was filed on Apr. 25, 2024, and which claims priority to German Patent Application No. 10 2023 112 582.6, which was filed in Germany on May 12, 2023, and which are both herein incorporated by reference.

### BACKGROUND OF THE INVENTION

### Field of the Invention

The invention relates to a radar fill level measuring device for detecting the level of a medium with low permittivity in a container.

### Description of the Background Art

Measuring the level of a medium inside a container using a radar fill level measuring device is a standard measurement task in process measurement technology, wherein the specific implementation of the radar fill level measuring device can vary greatly. When measuring levels with radar, two different arrangements and associated techniques are essentially used.

In both methods, a feed and receiving element for generating and receiving electromagnetic radiation is usually located outside the container whose fill level is to be monitored, which means that the associated control and evaluation electronics are also located outside the container. The electromagnetic radiation generated and emitted by the feed and receiving element enters the interior of the container through an opening in the container, is partially reflected at the surface of the medium in the container, the reflected electromagnetic radiation is captured by the transmitting and receiving element, and evaluation electronics then directly or indirectly obtain transit time information that provides information about the distance to the medium surface and thus the fill level of the medium in the container.

The electromagnetic radiation guided into the interior of the container via the opening in the container is either emitted in the container as a free space wave or the electromagnetic radiation is guided into the interior of the container via a cable, wherein the cable length also defines the measuring distance. Radar fill level devices that work with free space waves usually operate as frequency-modulated continuous wave (FMCW) radars, whereas wired radar fill level measuring devices usually work with a direct transit time evaluation of a pulse-shaped radar signal.

It is also known in the prior art to use waveguides for fill level measurement. In this case, the electromagnetic radiation generated by the feed and receiving elements is coupled directly into the waveguide outside the container. The waveguide extends from the outside of the container through an opening in the wall of the container into the interior of the container and runs inside the container over the measurement distance of interest. The feed and receiving elements and the waveguide, including the necessary attachments for mounting the radar fill level measuring device, form a mechanical unit here.

For radar distance measurements, it is essential that the surface of the medium of interest in the container reflects part of the electromagnetic radiation; more precisely, the interface between the medium of interest and the container not filled with the medium must produce a corresponding reflection. The reflectivity of the boundary layer depends on the refractive indices of the media involved, i.e., the refractive index of the medium in the container and the refractive index of the space not filled with the medium, which may be filled with air, a protective gas, or another medium, for example. Air has a permittivity close to 1.

The refractive index of a medium is calculated from the square root of the product of the relative magnetic permeability and the relative permittivity of the medium. Since the relative magnetic permeability for non-ferromagnetic materials is approximately equal to 1, the refractive index depends largely on the relative permittivity. If the medium has a refractive index (and thus a relative permittivity) close to 1, then the proportion of reflected electromagnetic radiation at an air interface is very small, which means that the reflected electromagnetic signal also has only a low intensity, so that the reflection signal originating from the medium may be very difficult to evaluate. The problem described occurs, for example, when the medium in the container is liquid hydrogen, which has a relative permittivity close to 1.

### SUMMARY OF THE INVENTION

It is therefore an object of the present invention to provide a radar fill level measuring device with which the fill level of a medium with low permittivity in a container can also be reliably determined by radar measurement.

The object is achieved, in an example, in the radar fill level measuring device described above with a feed and receiving element arranged outside the container for generating and receiving electromagnetic radiation, with a measuring window in the wall of the container that is permeable to electromagnetic radiation, with a waveguide arranged in the container and extending over a fill level measurement range, wherein the waveguide can be flooded by the medium. The feed element, the measuring window, and the waveguide form a measuring path over which, during measurement operation, the electromagnetic radiation generated by the feed element propagates through the measuring window and through the waveguide. Since the waveguide can be flooded by the medium, the medium in the container can easily penetrate the waveguide, so that electromagnetic radiation reflected from a medium surface in the waveguide is guided back through the waveguide and through the measuring window to the feed and receiving element.

The radar fill level measuring device described above works with a waveguide in the container. The waveguide has the advantage that the energy of the electromagnetic radiation coupled into the waveguide is practically completely preserved over the measuring distance, meaning that the measuring arrangement works with negligible attenuation. The use of the waveguide also has the advantage that relatively high energies of electromagnetic radiation can be used, so that even small reflection components lead to a relatively well-evaluable reflection signal.

The radar fill level measuring device can be preferably designed in several parts so that the feed and receiving elements, the measuring window, and the waveguide are mechanically decoupled from each other. This has the advantage that the seal of the container achieved by the measuring window is not affected by possible movements and/or mechanical stresses on the feed and receiving elements and/or the waveguide, and therefore the sealing effect cannot be negatively influenced, which is particularly important in the case of highly volatile media - in extreme cases, hydrogen.

A first example variation of the radar fill level measuring device can be characterized in that the waveguide is designed to be mono-mode with respect to the frequency of the electromagnetic radiation generated by the feed and receiving element. This means that only electromagnetic waves whose half-wavelength corresponds to the maximum dimension of the waveguide propagate in the waveguide.

In a further design of the radar fill level measuring device, the waveguide can be designed to be overmode with respect to the frequency of the electromagnetic radiation generated by the feed and receiving element, in particular as a circular waveguide or a rectangular waveguide. Preferably, the dimensions of the waveguide can be at most 3.5 times larger than in a corresponding mono-mode design, with the dimensions of the waveguide being at most 2.5 times larger than in a corresponding mono-mode design of the waveguide being particularly preferred. The waveguide is referred to as overmode because its dimensions are larger than would be necessary for guiding the mode that is actually excited. For example, only the fundamental mode is actually excited, but the waveguide has dimensions such that it could also transmit higher modes. This type of design has various advantages related to the group velocity of an excited mode - relative to the same frequency - increasing with the waveguide dimensions (cross-sections, diameters, axes of the cross-sections). At the same time, however, the frequency dependence of the group velocity decreases with increasing waveguide cross-sections. This has the effect that, with the proposed design, the measuring range is extended due to the higher group velocity with simultaneously reduced dispersion effects and thus reduced temporal “signal smearing.” The relationships can be better explained using corresponding diagrams, which are provided in the figure description.

In a further development of the radar fill level measuring device, care is taken to ensure that the feed and receiving elements specifically excite only the fundamental mode, in particular with a frequency above the cut-off frequency of the fundamental mode, i.e., in a range of reduced dispersion and higher group velocity. It is particularly preferable to work with a frequency as far above the cut-off frequency of the fundamental mode as possible without specifically exciting a higher mode; the advantages are identical to those described above.

A further advantage is that, at a given frequency of the electromagnetic radiation, the overmode waveguide has a larger cross-section, in which the capillary effects of the medium in the waveguide play a lesser role. The reflection surface is then flatter and, as a result, the usable reflection area is also larger than in a mono-mode waveguide design.

The end of the waveguide facing the measuring window can have an antenna for coupling electromagnetic radiation into and out of the waveguide. In particular, the antenna is a horn antenna.

The feed and receiving element can have an antenna for emitting the generated electromagnetic waves and for receiving the reflected electromagnetic waves, whereby the antenna is also preferably designed as a horn antenna. The use of antennas—on the waveguide or on the feed and receiving element—improves the overall directivity of the components, thereby improving the overall signal-to-noise ratio of the measuring section.

A beam shaping element can be arranged in the area of the measuring window to align and/or bundle the electromagnetic radiation between the feed and receiving element and the waveguide, also to improve the directivity of the components and to improve the signal-to-noise ratio. In a special configuration, the beam shaping element is placed on the outside of the measuring window and/or on the inside of the measuring window, for example in the form of lens elements. In a further configuration, the measuring window itself is designed as the beam shaping element and can thus partially or completely perform the function of the beam shaping element.

In the radar fill level measuring device described here, the electromagnetic transmission signal emitted by the feed and receiving element passes through the entire measuring distance and leaves the waveguide at its opening, which is located at the end of the waveguide facing away from the measuring window. The opening of the waveguide then usually points to a wall of the container. The electromagnetic radiation leaving the waveguide at that location is then reflected at the wall of the container or, if applicable, at other fixtures in the container and at least partially returns to the waveguide, where it is directed back toward the transmitting and receiving element. Under certain circumstances, this interference signal can be considerably stronger than the electromagnetic radiation reflected from the surface of the medium, which is the useful signal of interest; this is particularly the case with media with low permittivity, which are considered here. In an example of the radar fill level measuring device, a reflector can therefore be arranged in the area of an opening of the waveguide facing away from the measuring window, so that electromagnetic radiation emerging from the waveguide is not reflected back in the direction of the opening of the waveguide facing away from the measuring window. The reflector can be arranged on the wall of the container, for example, but it can also be attached to the waveguide itself.

Another measure to mitigate the problem of interference signals caused by reflection is provided in a further development of the radar fill level measuring device, in that a polarizer can be arranged in the area of an opening of the waveguide facing away from the measuring window, which polarizer polarizes the electromagnetic radiation emerging from the waveguide when reflected into such reflected electromagnetic radiation to which the transmitting and receiving element is not sensitive. The polarizer could, for example, cause a 90° phase shift of the electromagnetic radiation. The polarizer is also arranged on the wall of the container or, alternatively, on the waveguide itself.

A coded reflector can be arranged in the area of the waveguide opening facing away from the measuring window, which generates reflected electromagnetic radiation with a corresponding coded signature. In this variation, the reflected interference signal is not suppressed (as is the case with the polarizer), but the interference signal can be calculated from the received signal during signal processing due to its known signature, i.e., due to a known temporal signal curve. This solution therefore requires an evaluation unit—for example, based on a digital signal processor—to perform the corresponding signal processing.

In a further design of the radar fill level device, the feed and receiving elements and the measuring window, or rather the feed and receiving elements and a beam shaping element facing the feed and receiving elements (arranged on the measuring window) are aligned with each other in such a way that the electromagnetic radiation emitted by the transmitting and receiving element is not reflected back to the transmitting and receiving element, or only to a small extent. This measure also suppresses interference signals and improves the signal-to-noise ratio.

An alternative or additional measure for reducing reflections is to design the measuring window and/or the beam shaping element with an optical matching layer to reduce reflections. Preferably, this is a dielectric matching layer, wherein the permittivity of the material used for the matching layer is matched to the permittivity of the measuring window and/or the beam shaping element to which the matching layer is applied.

A mode converter can be arranged in the area of the opening of the waveguide facing the measuring window, which converts the electromagnetic radiation directed by the measuring window to the opening of the waveguide facing the measuring window into the desired mode. For example, the mode converter can convert a TE11 wave into a TE01 wave and vice versa. The advantage of the mode conversion mentioned as an example is that the TE01 mode requires a larger waveguide, which has a positive effect on capillary effects (reduced capillary effects). Deposits on the waveguide are less disruptive because there is less field in the outer area with this mode. Additional openings in the wall of the waveguide are also possible.

A mode converter can be arranged after the feed and receiving element, which converts the generated electromagnetic radiation into the desired mode outside the container.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, a radar fill level measuring device for detecting the level of a medium with low permittivity located in a container, FIGS. 2a to 2c schematically show, three examples of a radar fill level measuring device with different measures for combating the effect of interfering reflection signals,

FIG. 3 schematically shows, a radar fill level measuring device using a matching layer to reduce reflections,

FIG. 4 schematically shows, a radar fill level measuring device using a mode converter, and

FIGS. 5a and 5b show diagrams explaining the frequency dependence of the group velocity of waveguide waves and the effect of larger waveguide dimensions—due to the overmoded design of the waveguide—on the group velocity of the waveguide waves.

### DETAILED DESCRIPTION

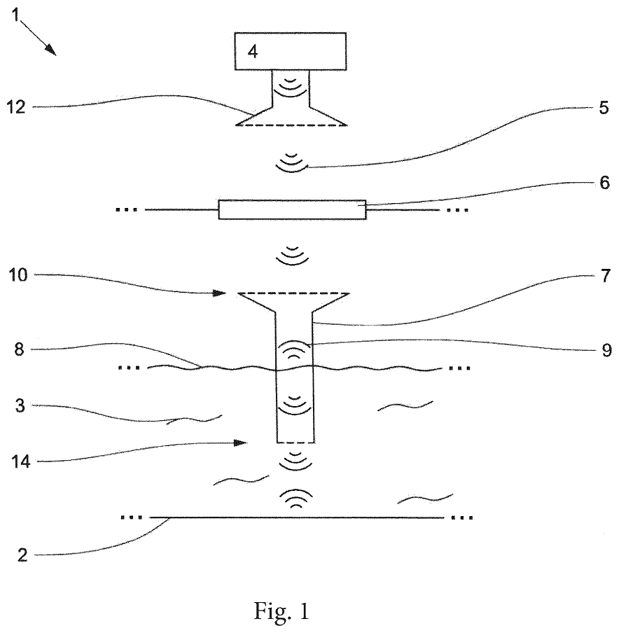

FIGS. 1 to 4 each show radar fill level measuring devices 1 and various aspects of their implementation. The radar fill level measuring devices 1 shown have in common that they are used to detect the level of a medium 3 with low permittivity located in a container 2. In the present case, the medium 3 is liquid hydrogen. The radar fill level measuring devices 1 have a feed and receiving element 4 outside the container 2 for generating and receiving electromagnetic radiation 5. They also have a measuring window 6 arranged in the wall of the container 2 and permeable to electromagnetic radiation 5, as well as a waveguide 7 in the container 2, each extending over a level measuring range, wherein the waveguide 7 can be flooded by the medium 3, i.e., the level of the medium 3 in the container 2 is identical inside and outside the waveguide 7.

The feed and receiving element 4, the measuring window 6, and the waveguide 7 form a measuring path through which the electromagnetic radiation 5 generated by the feed and receiving element 4 propagates through the measuring window 6 and through the waveguide 7 during measurement operation. Electromagnetic radiation 9 reflected by a medium surface 8 of the medium 3 in the waveguide 7 is guided back through the waveguide 7 and through the measuring window 6 to the feed and receiving element 4. If, as in the present case, the medium 3 has a permittivity close to 1, the electrical properties relevant for the propagation of electromagnetic waves at the medium surface 8 do not change or change only very slightly, so that only a small portion of the electromagnetic radiation 5 emitted by the feed and receiving element 4 is reflected as reflected electromagnetic radiation 9 from the medium surface 8. This means that the measurement signal of interest in the form of reflected electromagnetic radiation 9 is correspondingly weak and therefore difficult to evaluate.

The use of the waveguide 7 has the advantage of extremely low attenuation of the electromagnetic radiation 5 or the reflected electromagnetic radiation 9. In addition, the entire energy of the electromagnetic radiation 5 is concentrated and conducted through a defined surface area 8 of the medium 3, so that a defined useful signal is also generated in the form of the reflected electromagnetic radiation 9.

The radar fill level measuring device 1 in FIG. 1 operates with a waveguide 7 which is designed to be single-mode with respect to the frequency of the electromagnetic radiation 5 generated by the feed and receiving element 4, in this case as a circular waveguide. In the mono-mode design, the characteristic dimension in the cross-section of the circular waveguide (i.e., in the case of a circular waveguide, the diameter) is selected so that only a single wave mode, in this case the fundamental mode, can propagate.

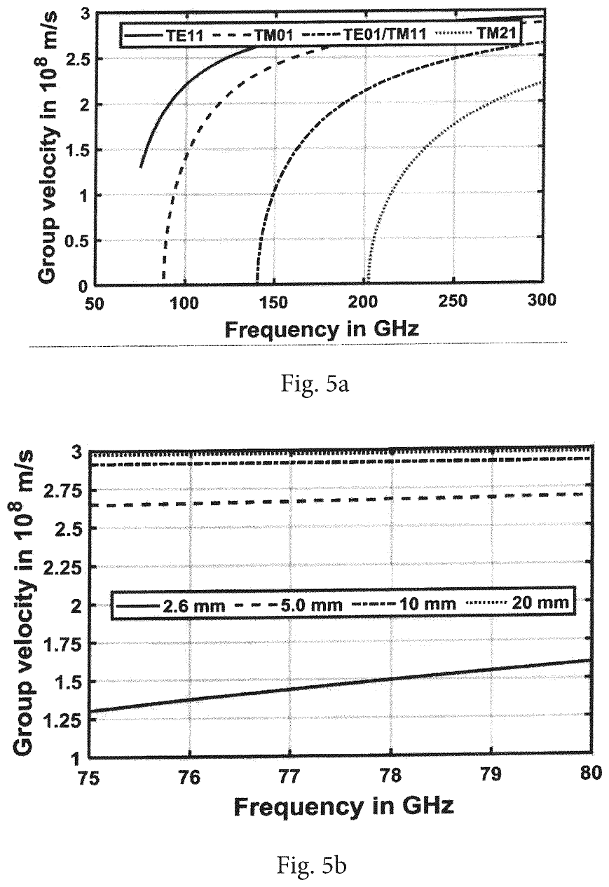

For a better understanding of the behavior of waveguide waves in waveguides, refer to FIG. 5a. The group velocities of different modes (TE11, TM01, TE01/TM11, TM21) of the waveguide waves are plotted against the frequency of the waveguide waves, with the TE11 wave being the fundamental mode and the subsequent waveforms denoting successively higher wave modes. The set of curves reflects the behavior for a waveguide with a constant relevant cross-sectional dimension (round waveguide with a diameter of 2.6 mm). As the frequency of the electromagnetic radiation increases and the wavelengths decrease, higher and higher wave modes become capable of propagating in the waveguide, which are also capable of propagating together when excited. A characteristic feature of waveguide waves is that they exhibit significant dispersion behavior, i.e., they have group velocities that depend on frequency. The frequency dependence of the group velocity is much more pronounced at low frequencies of a wave mode than at high frequencies. Even during single-mode operation of the radar fill level measuring device 1, dispersion effects usually occur because the excitation of a wave mode takes place with a signal having a certain bandwidth and thus with frequencies in the corresponding frequency range.

The radar fill level measuring devices 1 shown in FIGS. 2 to 4, on the other hand, operate with a waveguide 7 that is over-dimensioned with respect to the frequency of the electromagnetic radiation 5 generated by the feed and receiving element 4. This means that the dimensions of the waveguide are larger than is necessary for guiding the mode that is actually excited. In the examples, the dimension of the waveguide 7 relevant for the wave mode is 2.5 times larger than in a corresponding single-mode design of the waveguide 7. This design of waveguide 7 has proven to be very advantageous, as it represents a good compromise between achieving a high group velocity with low frequency dependence of the group velocity (i.e., low dispersion) and simultaneous design restriction to the propagation capability of only a few higher wave modes.

The fact that other wave modes can also be transmitted in an overmode waveguide 7 has already been explained in FIG. 5a, as has the fact that a wave mode achieves higher group velocities with lower dispersion as the frequency increases.

FIG. 5b shows how the group velocity in a frequency range changes for an excited wave mode when the dimensions of the waveguide 7 are changed, i.e., when it is increasingly overmode (from 2.6 mm to 5.0 mm, to 10 mm, and finally to 20 mm). Here, the effect is that as the mode becomes increasingly overmode, the group velocity increases, approaching the speed of light, and at the same time the dispersion decreases: the curves become significantly flatter.

If it could be ensured during operation of the radar fill level measuring device 1 that only the fundamental mode is excited and propagates, there would be no limit to the overmodulation. However, practice shows that, despite targeted excitation of the fundamental mode by the feed and receiving element 4, higher wave modes also form. This is particularly true in the case of disturbances in the measuring path, such as a moving or inclined reflection surface caused by the medium 3 in the waveguide 7. In this case, higher wave modes are also excited, so that energy is transferred from the specifically excited fundamental mode to the unintentionally generated higher wave modes. This leads to a weakening of the reflection signal in the fundamental mode and therefore to a more difficult detection and evaluation of the reflection signal in the fundamental mode by the feed and receiving element 4. The moderate overmodulation of waveguide 7 with a geometry factor of 2.5 compared to the mono-mode case has proven to be a good limitation of the propagatable higher modes (acceptable energy loss in higher modes), while at the same time providing a good increase in the group velocity of the waveguide waves in the fundamental mode and a good reduction in the dispersion of the waveguide waves in the fundamental mode. This results in an increase in the measuring range with good detectability of the reflection signal.

In the radar fill level measuring devices 1 shown in FIGS. 2 to 4, the feed and receiving element 4 specifically excites only the fundamental mode with a frequency above the cut-off frequency of the fundamental mode, i.e., in a range of reduced dispersion and higher group velocity. Special care is taken here to operate at a frequency as far above the cut-off frequency of the fundamental mode as possible without specifically exciting a higher mode.

In all radar fill level measuring devices 1, the end 10 of the waveguide 7 facing the measuring window 6 has an antenna 11 for the purpose of coupling electromagnetic radiation 5 into and out of the waveguide 7. This allows for better directivity of the arrangement, which also leads to an improvement in the signal-to-noise ratio.

The same applies to an antenna 12 provided on the feed and receiving element 4, which serves to radiate the generated electromagnetic radiation 5 and to receive the reflected electromagnetic radiation 9. In the examples shown, both antennas 11, 12 are designed as horn antennas.

The radar fill level measuring devices 1 shown in FIGS. 2a, 2b, 2c have a beam shaping element 13 arranged in the area of the measuring window 6, which serves to align and/or bundle the electromagnetic radiation 5 between the feed and receiving element 4 and the waveguide 7. The beam shaping element 13 can be formed of two lens-shaped elements, one of the beam shaping elements 13 being mounted on the outside of the measuring window 6 and the other beam shaping element 13 being mounted as a lens-shaped element on the inside of the measuring window 6. This measure also leads to an improvement in the signal-to-noise ratio of the measuring section.

The radar fill level measuring devices 1 shown in FIGS. 2a, 2b, and 2c show various measures for suppressing undesirable effects of reflected electromagnetic radiation that does not originate from the medium surface 8, i.e., interference signals. This concerns the influence of electromagnetic radiation 16 escaping from the waveguide 7, which is reflected, for example, by the wall of the container 2 and, provided it is reflected back into the waveguide 7, returns to the feed and receiving element 4. There it must be distinguished from a useful signal.

The radar fill level measuring device 1 according to FIG. 2a shows a reflector 15 arranged in the area of an opening 14 of the waveguide 7 facing away from the measuring window 6. This reflector 15 is arranged in such a way that electromagnetic radiation 16 emerging from the waveguide 7 is not reflected back in the direction of the opening 14 of the waveguide 7 facing away from the measuring window 6. In the present case, the reflector 15 is arranged on the wall of the container 2. In further examples, the reflector 15 can be attached to the waveguide 7.

In the radar fill level measuring device 1 according to FIG. 2b, a polarizer 17 is provided in the area of an opening 14 of the waveguide 7 facing away from the measuring window 6, which polarizes the electromagnetic radiation 16 emerging from the waveguide 7 when reflected into such reflected electromagnetic radiation to which the feed and receiving element 4 is not sensitive. Here too, the polarizer 17 is arranged on the wall of the container 2. However, it is also conceivable that the polarizer 17 could be attached to the waveguide 7. The polarizer 17 shown in FIG. 2b rotates the phase of the electromagnetic radiation 16 by 90°, so that the polarized electromagnetic radiation that returns to the feed and receiving element 4 has practically no effect there as interference signals, since the feed and receiving element 4 is not sensitive to such polarized electromagnetic radiation.

The radar fill level measuring device 1 according to FIG. 2c has a coded reflector 18 in the area of the opening 14 of the waveguide 7 facing away from the measuring windows 6, which generates reflected electromagnetic radiation with a correspondingly coded signature. This known coded signature can then be calculated from the overall reception signal by an evaluation unit using signal processing.

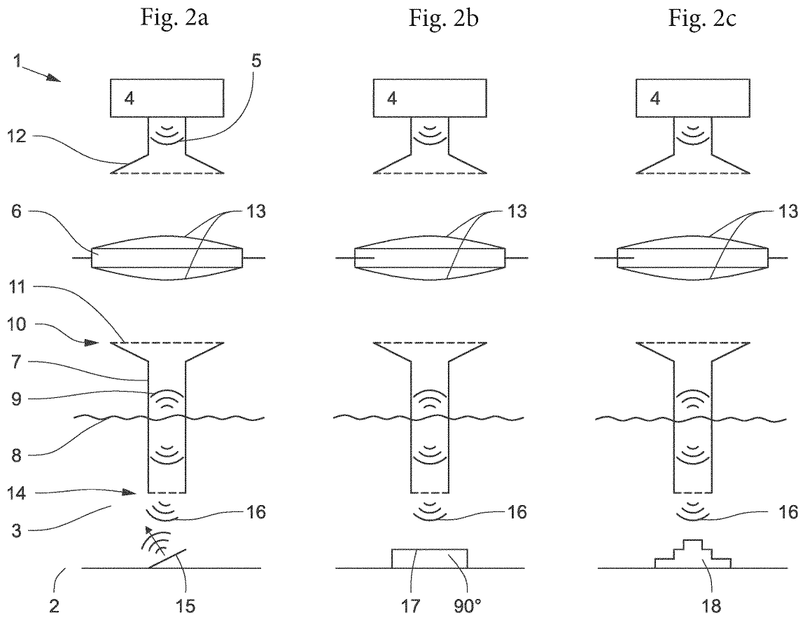

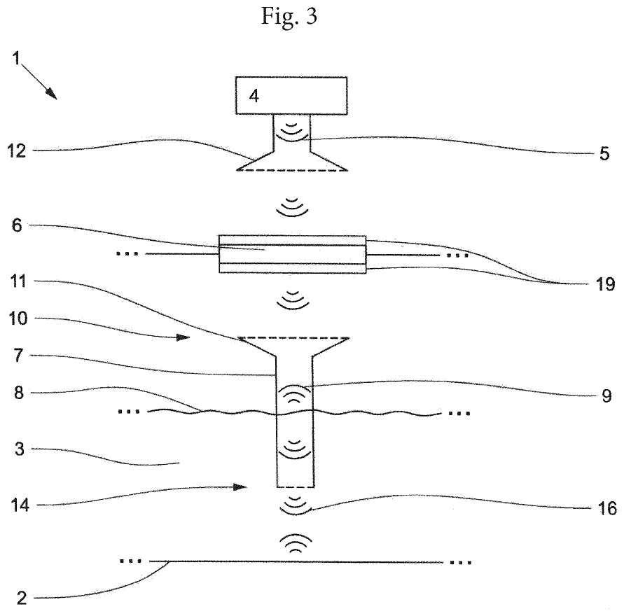

FIG. 3 shows that the measuring window 6 is equipped with a matching layer 19 to reduce reflections. In this case, the matching layer 19 is dielectric. The permittivity of the matching layer 19 must be selected depending on the permittivity of the measuring window 6 and the permittivity of the medium—in this case air—between the matching layer 19 and the feed-receiving element 4 or the waveguide 7 (usually the square root of the product of the two aforementioned permittivities).

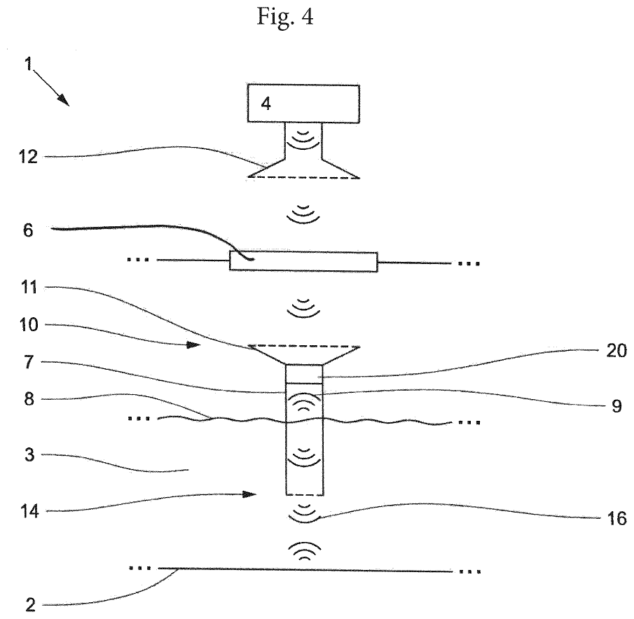

Finally, FIG. 4 shows a radar fill level measuring device 1 with a mode converter 20 arranged in the area of the opening 10 of the waveguide 7 facing the measuring window 6. The mode converter 20 converts the electromagnetic radiation 5 directed from the measuring window 6 to the opening 10 of the waveguide 7 facing the measuring window 6 into the desired mode. In this case, the mode converter 20 converts a TE11 wave into a TE01 wave. The advantage is that, compared to a mono-mode waveguide, the waveguide must be larger for the transmission of the TE11 mode, thereby minimizing possible capillary effects. In addition, the TE01 mode has lower losses compared to the TE11 mode. Furthermore, the field distribution reduces the influence of deposits at the edge and allows the introduction of additional openings.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A radar fill level measuring device to detect a level of a medium with low permittivity located in a container, the radar fill level measuring device comprising:
a feed and receiving element arranged outside the container to generate and receive electromagnetic radiation;
a measuring window arranged in the wall of the container that is transparent to electromagnetic radiation; and
a waveguide that is arranged in the container and that extends over a level measurement range, the waveguide being adapted to be flooded by the medium,
wherein the feed and receiving element, the measuring window, and the waveguide form a measuring path over which, during a measuring operation, electromagnetic radiation generated by the feed and receiving element propagates through the measuring window and propagates through the waveguide, and
wherein electromagnetic radiation reflected from a medium surface in the waveguide is guided back through the waveguide and through the measuring window towards the feed and receiving element.

2. The radar fill level measuring device according to claim 1, wherein the waveguide is designed to be monomode with respect to the frequency of the electromagnetic radiation generated by the feed and receiving element or designed to be a circular waveguide or a rectangular waveguide.

3. The radar fill level measuring device according to claim 1, wherein the waveguide is designed to be overmode with respect to the frequency of the electromagnetic radiation generated by the feed and receiving element, or designed to be a circular waveguide or a rectangular waveguide, wherein the dimensions of the waveguide are at most 3.5 times larger than in a corresponding mono-mode design, and wherein the dimensions of the waveguide are at most 2.5 times larger than in a corresponding mono-mode design of the waveguide.

4. The radar fill level measuring device according to claim 3, wherein the feed and receiving element specifically excites only the fundamental mode with a frequency above the cut-off frequency of the fundamental mode or in a range of reduced dispersion and higher group velocity or with a frequency as far above the cut-off frequency of the fundamental mode as possible, without specifically exciting a higher mode.

5. The radar fill level measuring device according to claim 1, wherein an end of the waveguide facing the measuring window has an antenna for coupling electromagnetic radiation into and out of the waveguide.

6. The radar fill level measuring device according to claim 1, wherein the feed and receiving element has an antenna for emitting the generated electromagnetic radiation and for receiving the reflected electromagnetic radiation or wherein the antenna is a horn antenna.

7. The radar fill level measuring device according to claim 1, wherein a beam shaping element is arranged in an area of the measuring window to align and/or focus the electromagnetic radiation between the feed and receiving element and the waveguide.

8. The radar fill level measuring device according to claim 7, wherein the beam shaping element is mounted on an outside of the measuring window and/or the beam shaping element is mounted on an inside of the measuring window and/or the measuring window itself is designed as at least part of the beam shaping element.

9. The radar fill level measuring device according to claim 1, wherein a reflector is arranged in the area of an opening of the waveguide facing away from the measuring window so that electromagnetic radiation emerging from the waveguide is not reflected back in the direction of the opening of the waveguide facing away from the measuring window, or wherein the reflector is arranged on the wall of the container.

10. The radar fill level measuring device according to claim 1, wherein a polarizer is arranged in the area of an opening of the waveguide facing away from the measuring window, wherein the polarizer polarizes the electromagnetic radiation emerging from the waveguide into reflected electromagnetic radiation to which the feed and receiving element is not sensitive, or wherein the polarizer is arranged on the wall of the container.

11. The radar fill level measuring device according to claim 1, wherein a coded reflector is arranged in the area of an opening of the waveguide facing away from the measuring window, which reflector, generates reflected electromagnetic radiation with a correspondingly coded signature.

12. The radar fill level measuring device according to claim 1, wherein the feed and receiving element and the measuring window or the feed and receiving element and a beam shaping element facing the feed and receiving element are aligned with each other such that the electromagnetic radiation emitted by the feed and receiving element is not reflected back to the feed and receiving element, or only to a small extent.

13. The radar fill level measuring device according to claim 1, wherein the measuring window and/or the beam shaping element is equipped with an adaptation layer to reduce reflections.

14. The radar fill level measuring device according to claim 1, wherein a mode converter is arranged in the area of the opening of the waveguide facing the measuring window, which converts the electromagnetic radiation directed by the measuring window onto the opening of the waveguide facing the measuring window into the desired mode.

15. The radar fill level measuring device according to claim 1, wherein a mode converter is arranged after the feed and receiving element, which converts the generated electromagnetic radiation into the desired mode already outside the container.
